(19) United States
(12) Patent Application Publication
(10) Pub. No.: US 2007/0175012 A1
(43) Pub. Date: Aug. 2, 2007

(54) Bowling pin re-manufacturing process

(75) Inventor: Chris Jose Kazanas, Grand Haven, MI (US)

Correspondence Address: DYKEMA GOSSETT PLLC, 10 S. WACKER DR., STE. 2300, CHICAGO, IL, 60606, US

(73) Assignee: Brunswick Bowling & Billiards Corp., Lake Forest, IL (US)

(21) Appl. No.: 11/345,532

(22) Filed: Feb. 1, 2006

(51) Int. Cl. B23P 6/00; B23P 19/04

(52) U.S. Cl. 29/402.01; 29/402.03

(57) ABSTRACT

A bowling pin refurbishing process is disclosed. The bowling pin refurbishing process comprises the following steps. First, providing a plurality of bowling pins. Each of the plurality of bowling pins having an outer surface and a base portion. Each of the plurality of bowling pins also comprising an existing post and an existing coverstock. The existing coverstock covering at least a substantial portion of the outer surface of each of the plurality of bowling pins. Second, selecting at least one bowling pin from the plurality of bowling pins. The selection process is based on a predetermined amount of wear on the bowling pin. Third, stripping the existing coverstock from the bowling pin. Finally, applying a new coverstock over at least a substantial portion of the outer surface of the bowling pin.

### FIELD OF THE PRESENT INVENTION

The Present Invention relates generally to the refurbishment of game pieces, and, more particularly, to the refurbishment and remanufacturing of bowling pins.

### BACKGROUND OF THE PRESENT INVENTION

It is customary in certain sports and leisure activities, such as, for example, bowling, to use various game pieces. These game pieces, such as, for example, bowling pins, baseball bats, cricket wickets and soccer goal posts, are subject to varying amounts of wear and tear and consequently require refurbishment or—although more costly—replacement.

Specific to the game of bowling, the game pieces are very unique, yet simple in design and use: A traditional bowling ball, spherical in shape, solid in density and generally urethane in composition, weighing up to 16 pounds, or up to 7.26 kilograms (there is no minimum weight, although the range of 11-16 pounds, or between 4.99-7.26 kilograms, is standard), depending on the player; and ten bowling pins, each substantially composed of a hard wood, such as, for example, maple, weighing between 48-52 ounces, or 1.36-1.47 kilograms, and shaped in a very unique, but standard, style.

During the course of its lifetime, a bowling pin is repeatedly subject to being struck by bowling balls traveling at relatively high speeds (approximately 25 feet (7.62 meters) per second). Moreover, since the contact surfaces of both the bowling ball and the bowling pin are generally of a round shape, the collision point between the two game pieces comprises a relatively small area. As a result, a very high shock force is delivered from the bowling ball to the bowling pin. Further, the reactionary movement of a bowling pin, after impact, into another bowling pin, the physical boundaries of the bowling lane or the bowling ball itself, can create a separate instance of the delivery of a high shock force from bowling pin to bowling pin.

As a result, the surface of a bowling pin is subject to denting, chipping, pitting and splintering, as well as to aesthetic defects such as discoloration. Consequently, there exists a need to develop a remanufacturing, or refurbishment, process on such used bowling pins. In the past, various attempts have been made to develop and promulgate an adequate process for refurbishing used bowling pins. However, most of these processes are primarily cosmetic in nature, and, consequently, fail to provide a complete and thorough refurbishment of the entire bowling pin, especially the most affected and damaged aspect of the used bowling pin, that being the covering protecting the inner wood core.

Thus, a need exists to overcome the disadvantages listed herein, and to provide a complete and thorough refurbishment process of a game piece and, in particular, a bowling pin.

### SUMMARY OF THE PRESENT INVENTION

The Present Invention provides a method for overcoming the above-listed disadvantages. To this end, a bowling pin refurbishing process is disclosed. The bowling pin refurbishing process comprises the following steps. First, providing a plurality of bowling pins. Each of the plurality of bowling pins having an outer surface and a base portion. Each of the plurality of bowling pins also comprising an existing post and an existing coverstock. The existing coverstock covering at least a substantial portion of the outer surface of each of the plurality of bowling pins. Second, selecting at least one bowling pin from the plurality of bowling pins. The selection process is based on a predetermined amount of wear on the bowling pin. Third, stripping the existing coverstock from the bowling pin. Finally, applying a new coverstock over at least a substantial portion of the outer surface of the bowling pin.

### BRIEF DESCRIPTION OF THE FIGURES

The Present Invention will best be understood with reference to the following detailed description of the present invention, taken in conjunction with the accompanying figures, in which:

FIG. 1 illustrates a partial cross-sectional view of a bowling pin, made in accordance with an embodiment of the Present Invention;

FIG. 2 illustrates a cross-sectional view of a cutout portion of the bowling pin of FIG. 1;

FIG. 3 illustrates a flow chart depicting the steps involved in accordance with one embodiment of a process for remanufacturing bowling pins;

FIG. 4 illustrates a bowling pin, as contemplated during one portion of the Flow Chart of FIG. 3;

FIG. 5 illustrates a bowling pin, as contemplated during one portion of the Flow Chart of FIG. 3;

FIG. 6 illustrates a bowling pin, as contemplated during one portion of the Flow Chart of FIG. 3;

FIG. 7 illustrates a bowling pin, as contemplated during one portion of the Flow Chart of FIG. 3; and

FIG. 8 illustrates a bowling pin, as contemplated during one portion of the Flow Chart of FIG. 3.

### DETAILED DESCRIPTION OF THE PRESENT INVENTION

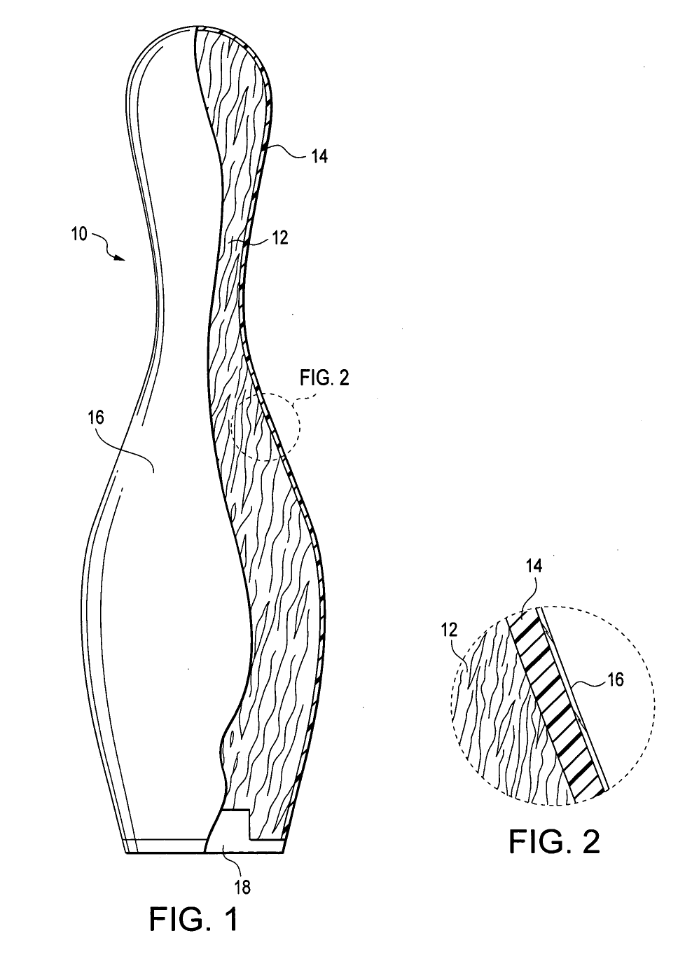

Referring now to the Figures, wherein like Reference Numerals are used to identify identical components in the various views, FIG. 1 illustrates a partial cross-section of representative game piece 10, made in accordance with the Present Invention. To aid in clarity, FIG. 2 illustrates the cutout portion, A, of FIG. 1. For purposes of the Present Invention, although the exemplary game piece, described with reference to FIGS. 1 and 2, is a bowling pin, it is nevertheless contemplated that the process described herein is applicable to other game pieces that, as a result of normal wear and tear, require refurbishment at some point during their lifetimes.

Referring to FIGS. 1 and 2, illustrative game piece 10 is illustrated as generally comprising body portion 12, coverstock 14, topcoat 16 and base 18. Body portion 12 preferably comprises any hardwood core traditionally used in the sport of bowling, such as, for example, maple. Body portion 12 is preferably shaped as shown, as that shape conforms to the requirements of the game of bowling.

To protect body portion 12 from the inevitable shock forces, as described above, body portion 12 is preferably covered with coverstock 14. For purposes of the Present Invention, the term “coverstock” refers to a protective coating that is applied to body portion 12 of representative game piece 10 (i.e., the bowling pin). Preferably, coverstock 14 is made of a plastic, such as, for example, an ionomeric material or a nylon. An example of such material is Surlyn®, which is manufactured by E. I. du Pont de Nemours and Company. However, it is contemplated that other like materials may be used. Application of coverstock 14 to body portion 12 is preferably through any appropriate means, although it is preferred that either injection molding or compression molding technologies be used. The purpose of coverstock 14 is to provide protection to body portion 12 of bowling pin 10, as coverstock 14 is meant to absorb the impact force resulting from collisions with bowling balls or other bowling pins. Consequently, any material meeting this purpose can be used as coverstock 14 for bowling pin 10.

A further layer of protection is found in the embodiment of topcoat 16. For purposes of the Present Invention, the term “topcoat” refers to the protective layer of a clear, preferably polyurethane-based resin that is applied to body portion 12 of bowling pin 10, after coverstock 14 is applied. Preferably, topcoat 16 is made of either urethanes or acrylics, although other similar materials are contemplated. Application of topcoat 16 to coverstock 14 covered body portion 12 is preferably through a known coating means; that is, by spraying, dipping or flowcoating. Alternatively, other methods of application of topcoat 16 to coverstock 14 covered body portion 12, are nevertheless contemplated. The purpose of the topcoat 16 is to provide additional protection to body portion 12 of bowling pin 10. In addition to providing additional protection to body portion 12 of bowling pin 10, topcoat 16 provides an shiny, aesthetic appearance to the bowling pin 10.

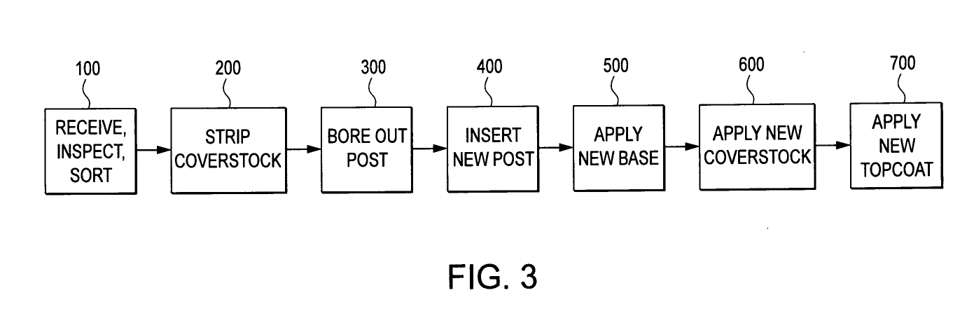

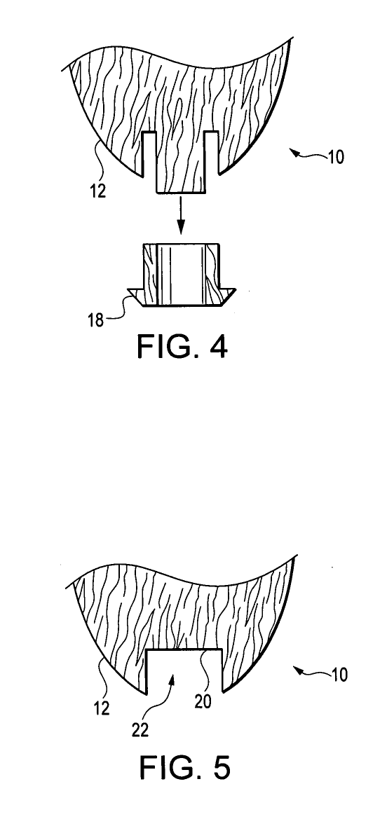

Depicted in the Flow Chart illustrated in FIG. 3 is one embodiment of a process for the refurbishment of a representative game piece, such as, for example, a bowling pin. In conjunction with FIG. 3, FIGS. 4-8 show illustrative, representative cross-sectional Figures of the bowling pin refurbishment process during selected Steps of FIG. 3.

Referring to FIG. 3, in Step 100, used bowling pins are received by a processor, which may or may not be machine-based. Upon receipt, each of the used bowling pins are then inspected and sorted. For cost efficiency, it is preferred that only those used bowling pins that possess a small amount of wear and tear are, in fact, refurbished; those used bowling pins that are extremely worn, unfortunately, cannot be refurbished. Since, during a game of bowling, individual bowling pins are subject to varying degrees of wear and tear, not every used bowling pin will be selected for refurbishment at the same point in its lifetime. To this end, a determination is made in Step 100, through the reception, inspection and sorting process, as to which used bowling pins are intended to be refurbished.

Alternatively, Step 100 may contemplate the inspection and sorting of used bowling pins into various levels of refurbishment. In this alternative, those used bowling pins selected for refurbishment would continue to the refurbishment process, while those needing less repair would be returned to use and, possibly, tagged for future reference and consideration. In this manner, the refurbishment processes described below would be applicable only to those used bowling pins that require such refurbishment (e.g., those used bowling pins not in need of a new base insert would not have that aspect of the refurbishment process, described below, applied thereto).

In Step 200, the used bowling pins that are required to be refurbished (or those used bowling pins that need some refurbishment) are stripped of all exterior paint and other treatments. More specifically, the used bowling pin is stripped of both its topcoat and its coverstock. Although, preferably, the base may be removed from the body portion of the bowling pin after the topcoat and coverstock are removed, it is nevertheless contemplated that circumstances may require the base to be removed prior to this Step 200. Preferably, the means by which a bowling pin is stripped would involve a two-step process; that is, to remove the topcoat, as well as to remove the coverstock. Preferably, removal of both the topcoat and the coverstock would be performed by standard procedures currently known in the art. For example, the topcoat and the coverstock may be removed by scraping or abrasion (sanding) means, or may be removed through the use of steam and/or heat transfer (i.e., convection, conduction and/or exposure to infrared heat), through the use of a lathe, etc.

As mentioned above, the base of the used bowling pin may also be removed. This is further illustrated in FIG. 4, which illustrates base 18 being removed from body portion 12 of bowling pin 10. In most instances, base 18 of body portion 12 of bowling pin 10 is held in place mechanically by coverstock 14 flowing into a groove in base 18, thereby “locking” it in place.

Alternatively, base 18 of body portion 12 of bowling pin 10 may be held in by an adhesive, such as, for example, glue or other similar type of adhesive. In this instance, removal of base 18 from body portion 12 would most likely, in such circumstances, entail the “de-adhesiveness” of the glue. That is, the effectiveness of the glue or other adhesive would need to be neutralized, though, for example, the use of a thinner or other chemical which breaks down the adhesive properties of the glue.

Alternatively, if base 18 is affixed to body portion 12 by other means, such as, for example, nails, then the nails would need to be removed prior to effecting the removal of base 18 from body portion 12.

In Step 300, the post of the used bowling pin is bored out. This Step 300 will only be performed when necessary (i.e., when the base is too degraded to be unable to be used in its current state). If this step is not necessary, the base may instead be sanded or milled to restore the base to an “as-new” surface finish. Referring to FIG. 5, it is shown that post portion 20 of body portion 12 of bowling pin 10 is bored out, resulting in opening 22.

The boring of the post of the used bowling pin is preferably done by standard and currently-known means. Such means include, for example, the use of a boring bit to remove any and all wood stock of the post portion of the body portion of the bowling pin.

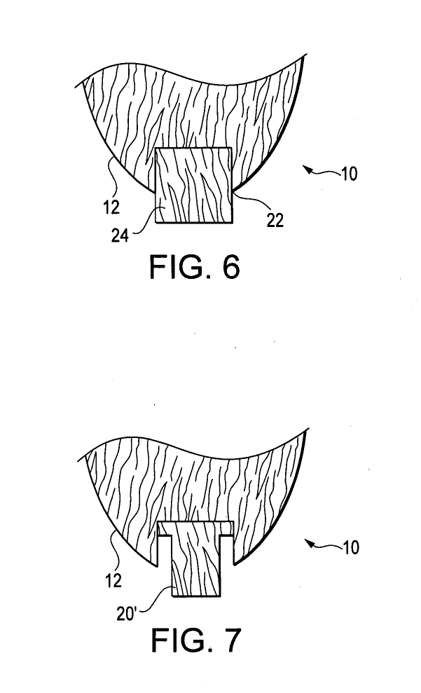

In Step 400, a new post portion is inserted into the bored-out opening and affixed to the bowling pin. This Step, as illustrated in FIG. 6, comprises a few substeps. In the first substep, post plug 24, which will eventually form the new post portion, is treated with an adhesive. The adhesive used in this substep will be used to affix the post portion in the bored-out opening of the bowling pin; thus, the adhesive should be suitable for this purpose, such as, for example, any known wood adhesive. In the second substep (and with reference to FIG. 6), post plug 24 is then inserted into bored-out opening 22 of bowling pin 10. In the third substep, post plug 24 is then customized in a manner so as to receive a new base. The means for customization is to provide a groove by which the new base can be affixed to bowling pin 10. At this point, post plug 24, now customized, becomes new post portion 20′ of bowling pin 10. This is best illustrated in FIG. 7.

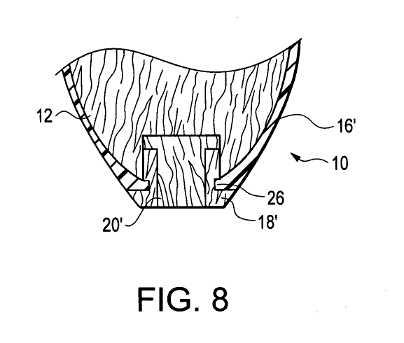

In Step 500, a new base is affixed to the bowling pin. This Step 500 is illustrated in FIG. 8. Referring to FIG. 8, it is shown that new base 18′ preferably differs from old base 18 in that new base 18′ comprises notch 26 disposed therein.

In Step 600, a new coverstock is applied. This Step 600 is illustrated in FIG. 8. Referring to FIG. 8, in this Step, new coverstock 16′ is applied to body portion 12 of bowling pin 10 in a currently-known manner. However, it is important to note that, this time, the process of applying new coverstock 16′ to body portion 12 of bowling pin 10 includes ensuring that new coverstock 16′ is fitted within notch 26 of new base 18′. To further protect against future wear, new coverstock 16′ may comprise a thicker width than old coverstock 16.

In Step 700, a new topcoat is applied. Preferably, the process by which the topcoat is applied to the nearly-refurbished bowling pin is currently known in the art, and comprises the coating of a urethane- or acrylic-based finish to the nearly-refurbished bowling pin.

At this point, the refurbished bowling pins are complete. The bowling pins can then be re-sold and used, as if they were any other bowling pin.

While only those embodiments set forth above have been described in detail, other configurations and embodiments for the Present Invention exist that are within the spirit and scope of the Present Invention.

What is claimed is:

1. A bowling pin refurbishing process, comprising the steps of:
providing a plurality of bowling pins, each of the plurality of bowling pins having an outer surface and a base portion, each of the plurality of bowling pins comprising an existing post and an existing coverstock, the existing coverstock covering at least a substantial portion of the outer surface of each of the plurality of bowling pins;
selecting at least one bowling pin from the plurality of bowling pins, the selection process being based on a predetermined amount of wear on the bowling pin;
stripping the existing coverstock from the bowling pin; and
applying a new coverstock over at least a substantial portion of the outer surface of the bowling pin.

2. The bowling pin refurbishing process of claim 1, further comprising the steps of:
removing the existing post from the bowling pin; and
inserting and affixing a new post in the bowling pin.

3. The bowling pin refurbishment process of claim 2, wherein the steps of removing and inserting are performed only if it is determined that the existing post needs replacement.

4. The bowling pin refurbishing process of claim 3, wherein the removing the existing post step comprises the step of boring out the existing post.

5. The bowling pin refurbishing process of claim 3, wherein the inserting and affixing step comprises the step of affixing the new post into the bowling pin using an adhesive.

6. The bowling pin refurbishing process of claim 1, further comprising the step of applying a topcoat over the new coverstock.

7. The bowling pin refurbishing process of claim 1, wherein the providing step further comprises providing a bowling pin having an existing base insert disposed on the bottom of the base portion of the bowling pin, and wherein the refurbishing process further comprises the step of replacing the existing base insert with a new base insert.

8. The bowling pin refurbishing process of claim 7, further comprising the steps of:
cutting a groove in the new post; and
inserting the new base insert into the groove in the new post.

9. A bowling pin refurbishing process, comprising the steps of:
providing a bowling pin having an outer surface and a base portion, the bowling pin comprising an existing post located within the bowling pin, an existing base insert disposed on the bottom of the base portion of the bowling pin, and an existing coverstock covering at least a substantial portion of the outer surface of the bowling pin;
stripping the existing coverstock from the bowling pin;
extracting the existing base insert from the bowling pin;
removing the existing post from the bowling pin;
affixing a new post in the bowling pin;
inserting a new base insert in the base; and
applying a new coverstock over at least the substantial portion of the outer surface of the bowling pin.

10. The bowling pin refurbishing process of claim 9, further comprising the step of applying a topcoat over the new coverstock.

11. The bowling pin refurbishing process of claim 9, wherein the removing the existing post step comprises the step of boring out the existing post.

12. The bowling pin refurbishing process of claim 9, wherein the affixing step comprises the step of affixing the new post into the bowling pin using an adhesive.

13. The bowling pin refurbishing process of claim 9, further comprising the steps of:
cutting a groove within the new post; and
inserting the base insert into the groove in the post.

14. A bowling pin refurbishing process, comprising the steps of:
providing a bowling pin having an outer surface and a base portion, the bowling pin comprising an existing post located within the bowling pin, an existing base insert disposed on the bottom of the base portion of the bowling pin, and an existing coverstock covering at least a substantial portion of the outer surface of the bowling pin;
stripping the existing coverstock from the bowling pin;
extracting the existing base insert from the bowling pin;
removing the existing post from the bowling pin;
affixing a new post in the bowling pin;
cutting a groove in the post;
inserting a new base insert in the groove in the post;
applying a new coverstock over at least the substantial portion of the outer surface of the bowling pin; and
coating the coverstock with a topcoat.

15. The bowling pin refurbishing process of claim 14, wherein the removing the existing post step comprises the step of boring out the existing post.

16. The bowling pin refurbishing process of claim 14, wherein the affixing step comprises the step of affixing the new post into the bowling pin using an adhesive.
